(19) United States
(12) Patent Application Publication
(10) Pub. No.: US 2021/0216079 A1
(43) Pub. Date: Jul. 15, 2021

(54) CART MOVING IN PARALLEL WITH INSTALLED OBJECT AND METHOD OF MOVING SAME

(71) Applicant: LG ELECTRONICS INC., Seoul (KR)

(72) Inventor: Hye Ri PARK, Seoul (KR)

(73) Assignee: LG ELECTRONICS INC., Seoul (KR)

(21) Appl. No.: 16/756,733

(22) PCT Filed: Mar. 12, 2019
(86) PCT No.: PCT/KR2019/002855

§ 371 Date: Apr. 16, 2020

(51) Int. Cl. G05D 1/02; B62B 5/00

(52) U.S. Cl. CPC G05D 1/0238; B62B 5/0069

(57) ABSTRACT

Disclosed herein are a cart moving in parallel with an installed object and a method of moving the same, the cart, which moves in parallel with an installed object, according to an embodiment including a control unit that senses obstacles around the cart, detects lines of installed objects around the cart, and then generates a moving route of the cart.

### TECHNICAL FIELD

The present disclosure relates to a cart moving in parallel with an installed object, and a method of moving the same.

### BACKGROUND

In spaces in which human resources and material resources are actively exchanged such as large-scale marts, department stores, airports, and golf courses, people carry various objects. In this case, devices such as carts can assist users to move objects.

Conventionally, users themselves handle and move carts. However, sometimes the carts move away from the user when the users distract attention from the carts in the above-described places. The users find it cumbersome to handle the carts.

Accordingly, required is a device such as a cart that can move following users without control by the users or that can move using electric energy on the basis of control by the users in order for the users to freely move and perform various activities. When carts autonomously or semi-autonomously moving are driven, the carts are not controlled by the users. Accordingly, they can collide with another cart. Additionally, when a cart is disposed obliquely in a space in which there are a large number of carts, the cart may interfere with movements of another cart. Accordingly, there is a growing need for a technology for moving a cart effectively considering characteristics of a space in which carts are placed.

### DISCLOSURE

### Technical Problems

One objective of the present disclosure is to control a cart such that the cart moves in parallel with an installed object such as a wall, a display stand and the like, thereby enhancing efficiency of movements of a plurality of carts in a space.

Another objective of the present disclosure is to provide a method for controlling parallel movements of a cart using information on lines in a space sensed by the cart, and a cart implementing the same.

Yet another objective of the present disclosure is to allow a cart to move in a space while being kept parallel and avoiding a collision with another cart.

The invention is not limited to the above-mentioned objectives, and other objectives and advantages of the invention which are not mentioned above can be understood from the following description and can be more apparently understood from embodiments of the invention. It can be easily understood that objectives and advantages of the invention will be able to be embodied by means described in the appended claims and combinations thereof.

### Technical Solutions

A cart, which moves in parallel with an installed object, according to an embodiment includes a controller that senses obstacles around the cart, detects lines of installed objects around the cart, and then generates a moving route of the cart.

A cart, which moves in parallel with an installed object, according to an embodiment includes a controller that detects a left line corresponding to a first installed object on the left side with respect to the cart, and a right line corresponding to a second installed object on the right side with respect to the cart, compares angles formed by the two lines and a reference line, and generates a moving route for the cart.

A cart, which moves in parallel with an installed object, according to an embodiment includes a controller that generates a vanishing point of lines on the left and right sides of the cart, and generates a moving route to place the cart close to any one of the installed objects on both sides.

A cart, which moves in parallel with an installed object, according to an embodiment includes a controller that detects line segments of the installed objects using values sensed by obstacle sensors disposed at two different heights, overlaps the line segments, and generates lines of the installed objects.

A method of moving a cart in parallel with an installed object according to an embodiment includes detecting a left line corresponding to a first installed object on the left side with respect to the cart, and a right line corresponding to a second installed object on the right side with respect to the cart using values sensed by obstacle sensors by a controller of the cart, and calculating a first angle between the left line and a reference line and a second angle between the right line and the reference line and generating a moving route such that the cart may be disposed in parallel with the first installed object or the second installed object while comparing the two angles by the controller.

A method of moving a cart in parallel with an installed object according to an embodiment includes detecting a line corresponding to an installed object on the left side or on the right side with respect to the cart by a controller of the cart, calculating an angle between the line and a reference line by the controller, and then generating a moving route such that the cart may be disposed in parallel with the installed object.

### Advantageous Effects

According to embodiments of the present disclosure, the cart may detect lines of installed objects such as walls, display stands and the like, and may move in parallel with the installed objects, thereby enhancing efficiency of movements of the cart in a space.

According to embodiments of the present disclosure, the cart may move in parallel to avoid a collision with a plurality of carts, thereby reducing the possibility that a cart autonomously or semi-autonomously moving collides with another cart.

According to embodiments of the present disclosure, the cart may sense a parallel direction in a space, thereby controlling a direction in which the cart moves without an additional device.

Effects of the present disclosure are not limited to the above-described ones, and one having ordinary skill in the art to which the disclosure pertains may easily draw various effects from the configuration of the disclosure.

### DESCRIPTION OF THE DRAWINGS

FIG. 1 shows an appearance of a cart according to an embodiment.

FIG. 2 shows components of a control module of a cart according to an embodiment.

FIG. 3 shows an installed object according to an embodiment.

FIG. 4 shows a graph in which lines of installed objects on both sides are detected when an obstacle sensor according to an embodiment is a LiDAR sensor.

FIG. 5 shows a graph in which lines of installed objects on both sides are detected when an obstacle sensor according to an embodiment is a distance sensor.

FIG. 6 shows lines and angles detected from installed objects according to an embodiment.

FIG. 7 shows a process in which a cart according to an embodiment detects parallel lines of installed objects and determines a driving direction.

FIG. 8 shows a process in which a controller according to an embodiment complements discontinuous lines.

FIGS. 9 and 10 show a process in which a cart according to an embodiment moves near an object installed on one side, out of objects installed in parallel on both sides.

FIG. 11 shows results of detecting lines using sensors disposed at different heights according to an embodiment.

FIG. 12 shows a single installed object sensed according to an embodiment.

FIG. 13 shows lines that are detected when an obstacle sensor according to an embodiment is a camera sensor capturing images.

FIG. 14 shows lines that are detected when an obstacle sensor according to an embodiment is a LiDAR sensor.

FIG. 15 shows a process in which a cart moves in parallel with lines of installed objects in a following mode according to an embodiment.

FIG. 16 shows s process in which a cart according to an embodiment moves in parallel with installed objects.

### BEST MODE

Hereinafter, embodiments of the disclosure will be described in detail with reference to the accompanying drawings such that the invention can be easily implemented by those skilled in the art. The invention can be embodied in various forms and is not limited to the embodiments.

Parts which are not associated with description will be omitted in order to clearly describe the disclosure, and the same or similar elements over the entire specification will be referred to by the same reference signs. Some embodiments of the invention will be described in detail with reference to the accompanying drawings. In the drawings, the same elements will be referred to by as the same reference signs as possible. In the following description, when detailed description of the relevant known configurations or functions is determined to obscure the important point of the present disclosure, the detailed description will be omitted.

Terms such as first, second, A, B, (a), and (b) can be used to describe elements of the invention. These terms are merely used to distinguish one element from another element and the essence, order, sequence, number, or the like of the elements is not limited to the terms. If it is mentioned that an element is “coupled” or “connected” to another element, it should be understood that the element is directly coupled or connected to another element or still another element may “interposed” therebetween or the elements may be “coupled” or “connected” to each other with still another element interposed therebetween.

In embodying the invention, elements can be segmented and described for the purpose of convenience of explanation, these elements may be embodied in one device or module, or one element or may be divided and embodied into two or more devices or modules.

Below, devices that move autonomously while following a user, or that are moved via the user's control on the basis of electric power are referred to as a smart cart or, for short, a cart. Carts may be used in a large-scale retail store, a department store, and the like. They may also be used in an airport, a port, and the like that are visited by many tourists. Further, they may be used in leisure spaces such as a golf course.

Additionally, carts include all types of devices that follow a user by tracking the position of the user and that have a predetermined storage space. They include all types of devices that move using electric power according to control such as a pushing action, a pulling action, and the like of a user. As a result, users may move a cart without controlling the cart, and may move the cart with a small amount of force.

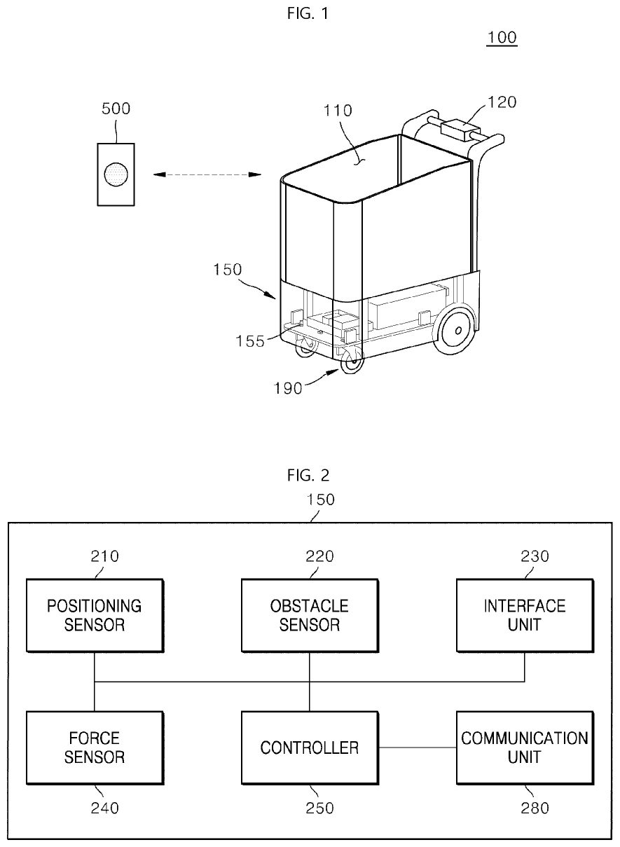

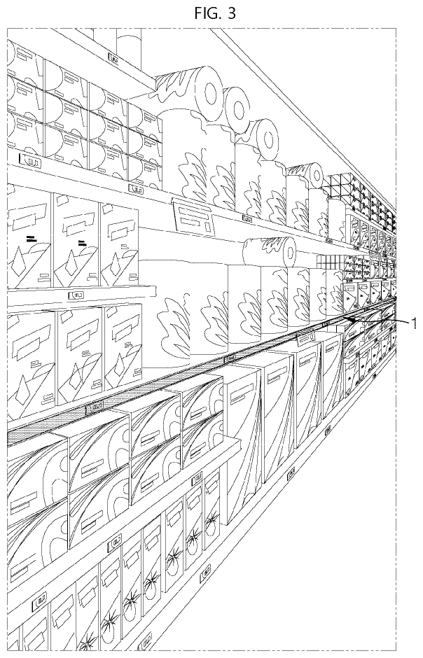

FIG. 1 shows an appearance of a cart according to an embodiment, and FIG. 2 shows components of a control module 150 of a cart according to an embodiment.

The cart 100 includes a storage unit 110, a handle assembly 120, a control module 150, and a driver 190. The storage unit 110 is a space in which a user stores or piles objects. The handle assembly 120 allows a user to control movements of the cart 100 manually or semi-automatically.

The user may push or pull the cart 100, or may change a direction of the cart 100, using the handle assembly 120. In this case, the cart 100 may move semi-automatically using electric energy on the basis of magnitude of force applied to the handle assembly 120 or on the basis of a difference in forces applied to the left and right of the handle assembly 120.

The control module 150 controls movements of the cart 100. Specifically, the control module 150 controls autonomous driving of the cart 100 such that the cart 100 may follow the user. Additionally, the control module 150 may control semi-autonomous driving (power assist) of the cart by assisting force of the user when the user pushes or pulls the cart using a small amount of force.

The control module 150 may control the driver 190. Additionally, positioning sensors for tracking the position of the user to follow the user may be disposed in various portions of the cart 100. Further, obstacle sensors for sensing surrounding obstacles may be disposed in various portions of the cart 100.

The obstacle sensor 220 senses obstacles disposed around the cart. The obstacle sensor 220 may sense a distance between the cart and a human, a wall, an object, a fixed object, an installed object and the like, or may capture images of an object/a human/an installed object and the like around the cart. The obstacle sensor 220 may be disposed at a lower end of the cart 100.

For example, a plurality of obstacle sensors 220 may be disposed in an area indicated by Ref No. 155 to sense obstacles at the front side/left side/right side/rear side of the cart. The obstacle sensors 220 may be disposed at the same height of the lower end of the cart 100, or two or more obstacle sensors 220 may be disposed at different heights of the lower end of the cart 100. Further, the obstacle sensor 220 may be disposed on a front surface/both lateral surfaces of the cart in a direction in which the cart 100 moves. When the cart 100 moves backward, the obstacle sensor may be disposed on the front surface and the rear surface, and both of the lateral surfaces of the cart.

The positioning sensor 210 is a necessary component of the cart, which assists autonomous driving. In the case of a cart that assists only semi-autonomous driving (power assist), the positioning sensor 210 may be optionally provided.

The positioning sensor 210 may track the position of a user having a transmitter module 500, and may be disposed at an upper end of the cart 100. However, the positions of the sensors may vary depending on embodiments. The present disclosure is not limited to what has been described. Additionally, regardless of the positions of the sensors, the control module 150 controls the sensors or uses information sensed by the sensors. That is, the sensors are logical components of the control module 150 regardless of their physical positions.

The handle assembly 120 may include an interface unit to output predetermined information to the user, and the interface unit may also be a component controlled by the control module 150. The handle assembly 120 includes a force sensor 240 that senses forces of pushing or pulling the cart by the user. The force sensor 240 may be disposed outside of or inside the cart 100 to which different magnitudes of forces are applied by manipulation of the handle assembly 120. The position or the configuration of the force sensor 240 may vary. Embodiments of the present disclosure are not limited to a specific force sensor 240.

FIG. 2 shows logical components constituting a control module 150 such as a positioning sensor 210, a force sensor 240, an obstacle sensor 220, an interface unit 230, a controller 250, and a communication unit 280.

The positioning sensor 210 receives a signal from the transmitter module 500 and measures the position of the transmitter module 500. When the positioning sensor 210 uses the ultra-wideband (UWB), a user can carry a transmitter module 500 that transmits a predetermined signal to the positioning sensor 210. The positioning sensor 210 can ascertain the position of the user on the basis of the position of the transmitter module 500. For example, the user may carry a transmitter module 500 of a band type which is worn on the user's wrist.

The force sensor 240 may be disposed in the handle assembly 120 or may be disposed outside of or inside the cart 100 connected to the handle assembly 120. The force sensor 240 is disposed in the handle assembly 120, and senses magnitudes, changes and the like of forces when the user applies force to the handle assembly 120. The force sensor 240 includes various sensors such as a hall sensor, a magnet-type sensor, a button-type sensor and the like. The force sensor 240 is comprised of a left force sensor and a right force sensor, and the left force sensor and the right force sensor may be respectively disposed in the handle assembly 120 or inside or outside of the cart 100.

The obstacle sensor 220 senses an obstacle around the cart.

The controller 250 cumulatively stores position information of a transmitter module and generates a moving route corresponding to the stored position information of the transmitter module. In order to cumulatively store the position information, the controller 250 can store the position information of transmitter module 500 and cart 100 as absolute position information (absolute coordinates) based on a predetermined reference point.

Additionally, the controller 250 detects lines of installed objects around the cart using values sensed by the obstacle sensor 220. The lines of installed objects refer to lines corresponding to a direction in which the installed objects such as display stands or walls are placed, and refers to tangent lines between the ground surface and the installed objects or lines parallel to the tangent line and placed higher than the ground surface. For example, when a display stand for displaying objects is an installed object, shelves of the display stand may form lines. Additionally, when a bookshelf is an installed object, shelves on which books are placed may form lines.

The controller 250 generates a moving route of the cart using detected lines. For example, the controller 250 allows the cart to move in parallel with detected lines of installed objects.

The driver 290 moves along a moving route generated by the controller 250. Movements of the driver 190 are based on rotation speeds, rotation frequencies, directions of rotation and the like of wheels, and the controller 250 may ascertain the position of the cart 100. The moving route generated by the controller 250 includes angular velocity applied to the left wheel and the right wheel of the cart.

The cart 100, following the transmitter module on the basis of position information of the transmitter module 500, includes embodiments of FIGS. 1 and 2.

The communication unit 280 remotely upgrades software of the control module 150, or when the positioning sensor 210 may not measure the position of the transmitter module 500, receives position information of the transmitter module 500 from the outside.

A predetermined advertisement may be output to the interface unit 230, and the communication unit 280 may receive information such as an advertisement or a message and the like to be output to the interface unit 230. Additionally, the communication unit 280 may transmit information on a product stored in the storage unit 110 to an external server such that a payment is readily made in an unmanned store.

The obstacle sensor 220 ascertains the positions of installed objects in a space in which the cart moves. For example, when the obstacle sensor 220 is a LiDAR sensor or a distance sensor, the obstacle sensor 220 may sense lines of installed objects disposed externally. The installed objects may be walls, display stands (shelves) in a store, and the like.

The installed objects are disposed in a space parallelly or perpendicularly. Accordingly, ground surface lines of the installed objects form a straight angle or a right angle. Thus, the cart capable of autonomously/semi-autonomously moving may detect parallel straight lines of display stands, and may move on the basis of tilt angles of the straight lines.

Below, a mode in which the cart 100 measures the position of the transmitter module 500 using the positioning sensor 210, and autonomously move by following a user is referred to as a following mode. Additionally, a mode in which the force sensor 240 senses force applied to the handle assembly 120 of the cart 100, and the cart semi-autonomously moves is referred to as a power assist mode. In the power assist mode, the controller 250 determines a direction in which the cart moves or a speed at which the cart moves in response to the force sensed by the force sensor 240, and moves the driver 190. This disclosure presents a technology for disposing the cart 100 in parallel near installed objects in the following mode or the power assist mode.

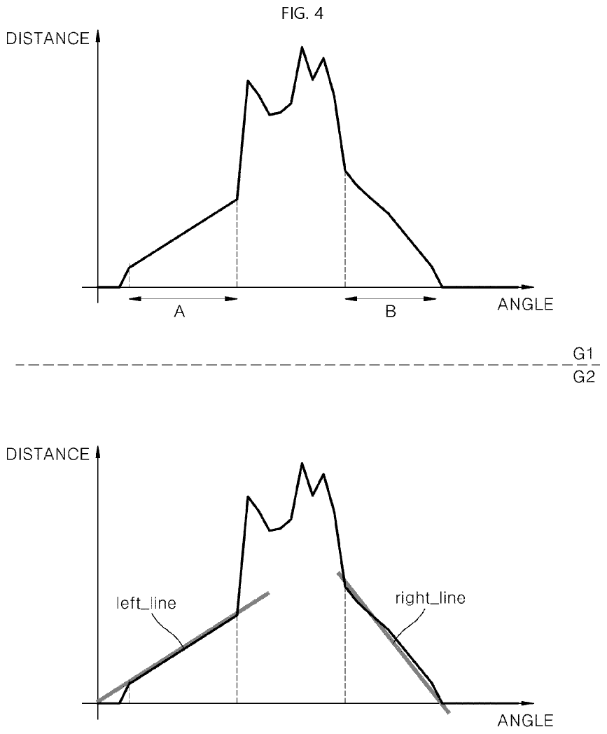

FIG. 3 shows an installed object according to an embodiment. The installed object in FIG. 3 is a display stand on which a plurality of products are piled. The thick line indicated by Ref No. 1 in FIG. 3 denotes a height at which the obstacle sensor 220 of the cart senses external obstacles when the cart senses an obstacle at a certain height.

The obstacle sensor 220 may detect the line indicated by Ref No. 1 as a result of sensing the installed object. The controller 250 may determine that the cart is between installed objects disposed in parallel when the line, indicated by Ref No. 1 and detected during the process of sensing obstacles, is disposed on both sides and has a certain range of angles.

When the obstacle sensor is a camera sensor is, the controller 250 may detect a line 1 that is an oblique line in a forward direction in an image captured by the camera sensor.

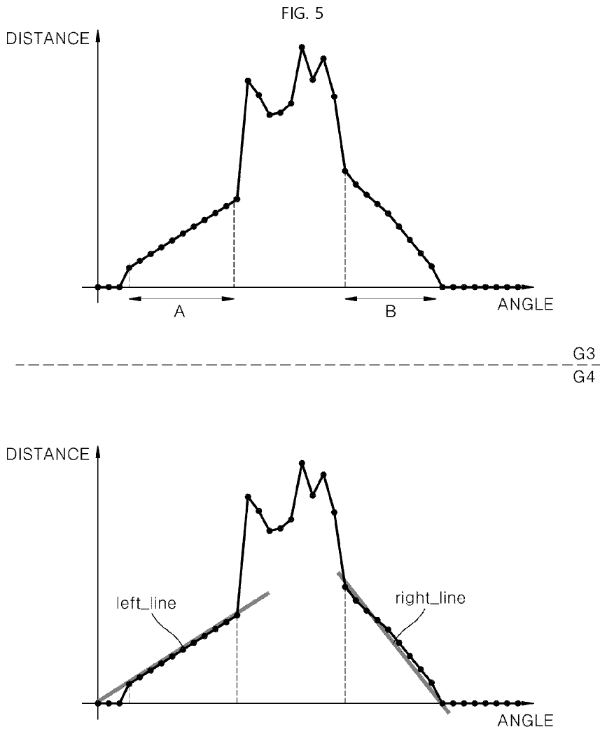

FIG. 4 shows a graph in which lines of installed objects on both sides are detected when an obstacle sensor according to an embodiment is a LiDAR sensor. Ref No. G1 in FIG. 4 is a graph generated as a result of sensing obstacles disposed in front of the cart by a LiDAR sensor. G1 shows a distance sensed at each angle on the basis of results of sensing the obstacles in front of the cart at 180 degrees by the LiDAR sensor.

The controller 250 may generate G1 by converting the distance sensed at each angle into distance information with respect to the cart. The controller 250 detects lines in section A and in section B of G1. Thus, the controller 250 may calculate lines (left_line, and right_line) as in G2.

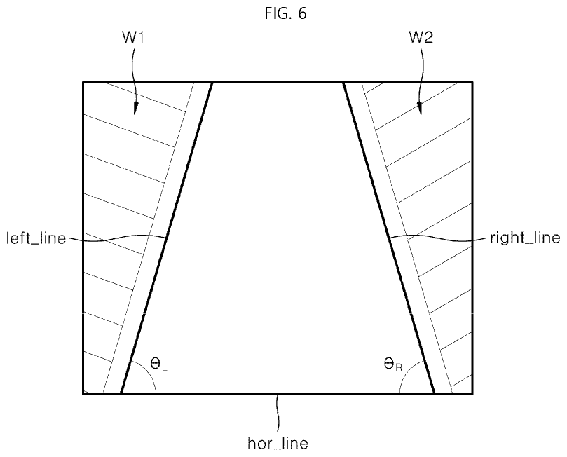

FIG. 5 shows a graph in which lines of installed objects on both sides are detected when an obstacle sensor according to an embodiment is a distance sensor. The distance sensor includes an ultrasonic sensor, an infrared sensor and the like. Ref No. G3 in FIG. 5 is a graph showing a distance between obstacles and the cart, which is calculated by a plurality of distance sensors attached to the cart on the basis of results of sensing obstacles in front of the cart by the plurality of distance sensors.

Ref No. G3 in FIG. 5 shows distances between the cart and obstacles, which are sensed by the distance sensors of the cart, disposed from the left. The controller 250 may convert the distances sensed by each distance sensor into distance information with respect to the cart, and may generate G3. The controller 250 detects lines in section A and section B of G3. Thus, the controller 250 may calculate lines (left line, and right_line) as in G4.

The obstacle sensor 220 may calculate a distance between an installed object and the cart using a depth sensor in addition to the above-described sensors. Additionally, the cart 100 may use a regular camera sensor as the obstacle sensor 220, and the controller 250 may detect lines in an image.

The obstacle sensor 220, as illustrated in FIGS. 4 and 5, is disposed exterior of the cart at height H from the floor, and senses surrounding obstacles disposed at height H. When installed objects are disposed on both sides at height H, the cart my detect lines sensed at height H of the installed objects on both sides. Additionally, the cart determines a direction of rotation with respect to the detected lines.

That is, the controller 250 detects a left_line corresponding to a first installed object disposed on the left side with respect to the cart, and detects a right_line corresponding to a second installed object on the right side with respect to the cart. The controller 250 generates a moving route using the lines such that the cart 100 may move in parallel between two installed objects (the first installed object/second installed object) disposed to face each other.

FIGS. 4 and 5 show that lines, converged at a vanishing point, are generated according to a sensed distance even when installed objects are disposed in parallel. When two lines are detected on the left and right sides with respect to the cart, the controller 250 determines a direction in which the cart moves according to tilt angles of the lines.

When the obstacle sensor 220 is a LiDAR sensor or a distance sensor, the controller 250 may generate a distance value of an obstacle sensed by the obstacle sensor 220 as in FIG. 4 or FIG. 5. In this case, the controller 250 may generate a single line using distance information on obstacles at two points, sensed by the obstacle sensor, i.e., a sub-line connecting the two points. The controller 250 may generate a line such that a difference between a gradient of the line and gradients of the line segments may be within an error range.

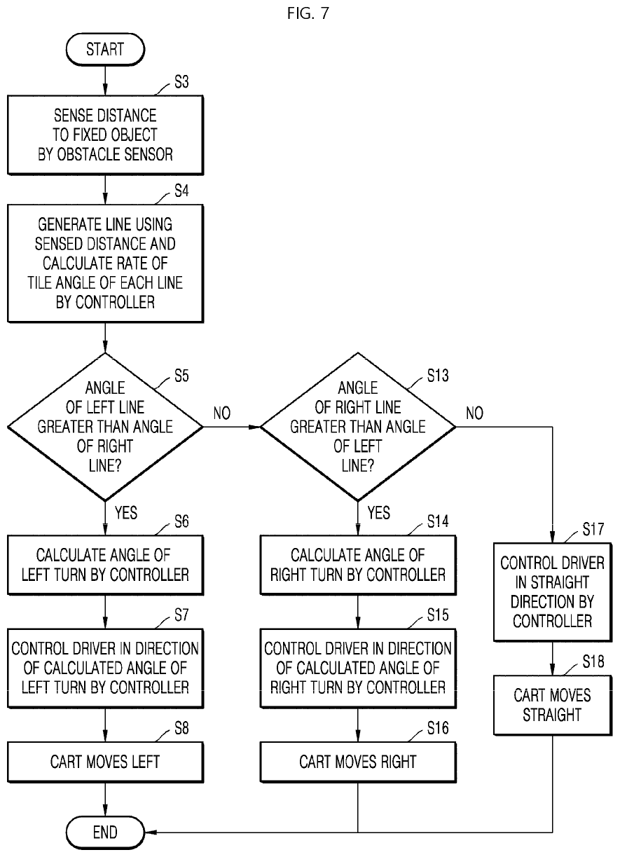

FIG. 6 shows lines and angles detected from installed objects according to an embodiment. The controller 250 generates the left_line/right_line in FIG. 6 using results of sensing the installed objects by the obstacle sensor 220. Angles formed between a hor_line, which is a reference (horizontal) line perpendicular to the direction in which the cart moves, and the above-described lines are respectively indicated as a first angle (θ_{L}), and a second angle (θ_{R}). The controller 250 determines the direction in which the cart moves, using a rate of degrees (θ_{L}, and θ_{R}) to which two straight lines (the left_line and right_line) facing each other are tilted, or a difference of angles at which two straight lines (the left_line and right_line) facing each other are tilted and the like, at an installed object such as a display stand.

Thus, the controller 250 may allow the cart to move straight in parallel with the installed objects. Additionally, when a plurality of carts is disposed near a display stand, the carts may autonomously move near the display stand not to interfere with movements of another cart or people.

That is, the controller 250 generates a moving route while comparing the first angle (θ_{L}) and the second angle (θ_{R}) such that the cart is disposed in parallel with the first installed object (W1) or the second installed object (W2).

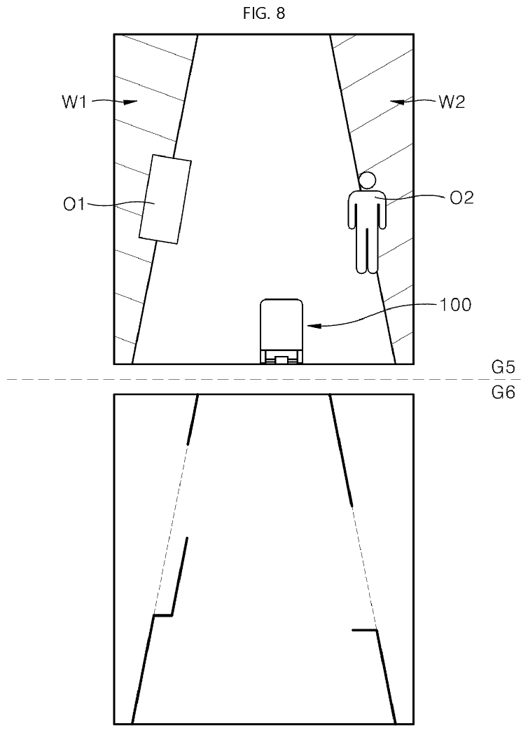

FIG. 7 shows a process in which a cart according to an embodiment detects parallel lines of installed objects and determines a driving direction. When installed objects on both sides are sensed at a certain height in the case in which the installed objects (W1, and W2) are disposed in parallel on both sides with respect to the cart in a space, lines are detected. The controller 250 determines a direction in which the cart moves by comparing angles of the detected lines.

The obstacle sensor 220 senses a distance between surrounding installed objects (obstacles) and the cart (S3). The above-described LiDAR sensor, a distance sensor and the like sense a distance between an installed object and the cart. The controller 250 generates lines using the sensed distances, and calculates a rate of tilt angles of each line (S4). Generation of lines and angles has been described with reference to FIGS. 3 to 6. Additionally, the controller 250 compares angles of the left line and the right line (S5).

When an angle (θ_{L}) of the left line is greater than an angle (θ_{R}) of the right line as a result of comparison, the controller 250 determines that the cart faces the right side. Additionally, the controller 250 calculates an angle for a left turn (S6). The controller 250 may calculate an angle for a left turn using a difference in magnitudes or rates of angles (θ_{L}, and θ_{R}) of the two lines. The controller 250 controls the driver 190 in a direction of the calculated angle for a left turn (S7). The cart turns left (S8).

When the angle of the left line is less than the angle of the right line in step 5, i.e., when the angle (θ_{R}) of the right line is greater than the angle (θ_{L}) of the left line as a result of comparison in step 13, the controller 250 determines that the cart faces the left side. Additionally, the controller 250 calculates an angle for a right turn (S14). The controller 250 may calculate an angle for a right turn using a difference in magnitudes or rates of angles (θ_{L}, and θ_{R}) of the two lines. The controller 250 controls the driver 190 in a direction of the calculated angle for a right turn (S15). The cart turns right (S16).

When the angle of the right line and the angle of the left line are the same in step 13, the cart 100 is disposed in parallel with respect to installed objects on both sides. Accordingly, the controller 250 controls the driver 190 such that the driver moves straight (S17). The cart moves straight (S18).

At the time of a left turn/right turn, the controller 250 may convert magnitudes or rates of two angles (θ_{L} and θ_{R}) into magnitudes or rates of angular velocity of a motor, which is applied to the left wheel and the right wheel of the driver 190, and may apply the converted magnitudes or rates.

In the case of autonomous driving, or semi-autonomous driving on the basis of the function of power assist, the controller 250 may detect two parallel lines (tilted from a perpendicular direction) of a display stand using values sensed by the obstacle sensor (a depth sensor, a LiDAR sensor, a distance sensor, and the like).

Additionally, the controller 250 acquires tilt angles of the two lines, and calculates a rate of the two angles or a difference of the two angles and the like. The controller 250 applies the calculated difference/rate and the like of the two angles to angular velocity applied to both wheels, and allows the cart to move in parallel with the installed object.

As a result, the cart 100 repeats left-turn driving or right-turn driving until a rate of tilt angles of the two lines is 1:1, and when a rate of angles of the longest sides is 1:1, moves straight. Herein, when the obstacle sensor 220 uses a depth sensor or a stereo camera, step 3 may be omitted, and the controller 250 may generate lines in an image.

The process in FIG. 7 is briefly described as follows. In order to move in parallel with an installed object, the cart performs following steps. First, the cart 100 performs sensing an obstacle disposed near the cart 100 using an obstacle sensor 220 (S3).

Next, a controller 250 of the cart 100 performs detecting a left line corresponding to a first installed object disposed on the left side with respect to the cart 100, and a right line corresponding to a second installed object disposed on the right side with respect to the cart 100 using values sensed by the obstacle sensor (S4). Next, the controller 250 performs calculating a first angle between the left line and a reference line, and a second angle between the right line and the reference line (S4).

Additionally, the controller 250 performs generating a moving route such that the cart 100 may be disposed in parallel with the first installed object or the second installed object while comparing the first angle and the second angle (S5˜S18).

In S7 and S15, the controller determines angular velocity of the left wheel of a driver or angular velocity of the right wheel of the driver according to a rate of the first angle (θ_{L}) and the second angle (θ_{R}). The controller 250 determines angular velocity of both wheels respectively, and accordingly, the cart may turn left/right or may move straight.

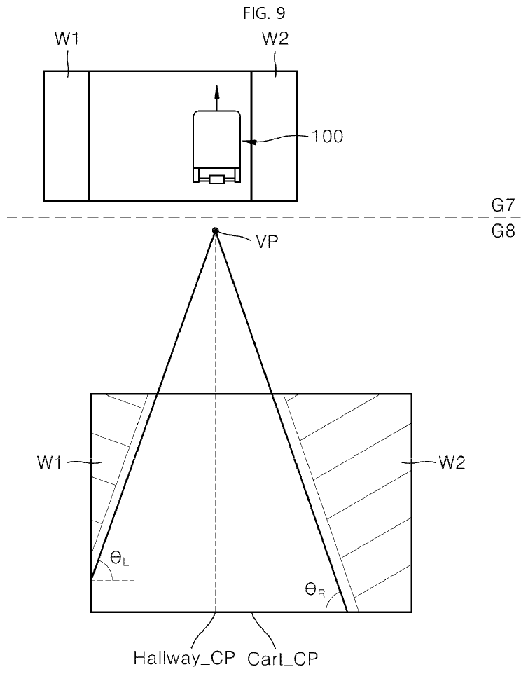

FIG. 8 shows a process in which a controller according to an embodiment complements discontinuous lines.

Ref No. G5 in FIG. 8 shows an embodiment of line detection when obstacles are disposed near the installed objects. In FIG. 8, the installed object (W1) on the left side is a display stand, and a product (01) protrudes and is piled. The installed object (W2) on the right side is also a display stand, and a person (02) is standing near the display stand.

Ref No. G6 in FIG. 8 shows a graph of distances sensed by the cart 100 in G5. Distances sensed by the obstacle sensor 220 are expressed as the solid lines of G6. The controller 250 may calculate gradients, i.e., angles of the solid lines on the basis of the left solid line and the right solid line.

Specifically, the controller 250 places virtual extended lines (dotted lines) between the discontinued solid lines to determine whether the cart is disposed between installed objects that are parallel, to calculate a gradient more accurately.

For example, the controller 250 may place a dotted line maintaining a gradient the same as the left lines or within an error range of gradients of the left lines between the discontinued portions of the left solid line. Likewise, the controller 250 may place a dotted line maintaining a gradient the same as the right lines or within an error range of gradients of the right lines between the discontinued portions of the right solid line.

When a line of an installed object is discontinuously detected due to placement of a broken object and a protruding object, movements of a person and the like, the controller 250 may calculate gradients of detected lines, or to enhance accuracy, may confirm continuity of discontinuous lines, may extend (add the dotted lines in FIG. 8) the discontinuous lines, and may calculate the gradients of the lines.

The controller 250 detects a plurality of discontinuous line segments, may extend the line segments and may generate extended lines.

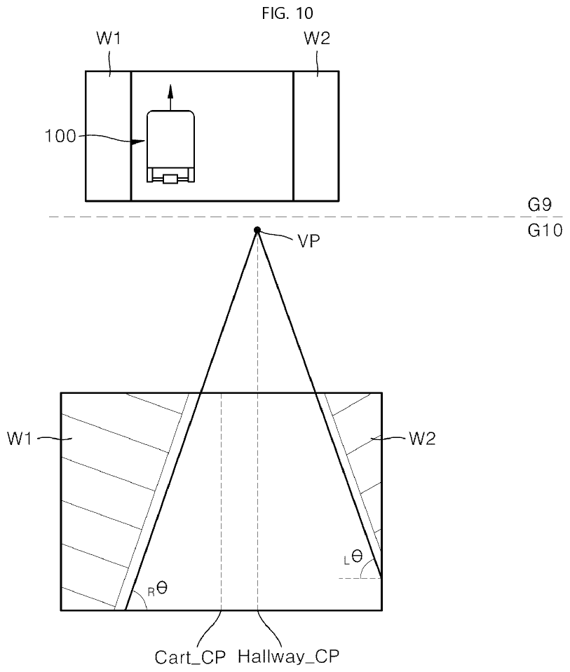

FIGS. 9 and 10 show a process in which a cart according to an embodiment moves near an object installed on one side, out of objects installed in parallel on both sides. FIG. 9 shows lines of installed objects, which are sensed by the obstacle sensors of the cart 100 when the cart 100 is disposed close to the installed object (W2) on the right side between installed objects (W1, and W2) on both sides (G7).

The controller 250 disposes the cart 100 in parallel with the installed objects using a rate or a difference in degrees (θ_{L}, and θ_{R}) to which the two lines are tilted. Additionally, the controller 250 may confirm which of the two installed objects (W1, and W2) is closer to the cart 100 using a vanishing point of the two lines.

That is, the controller 250 extends the left line and the right line, generates a vanishing point, and then compares the position of the vanishing point and the center of the cart. As a result of comparison, the controller 250 confirms whether the position of the cart is close to the installed object on the left side, or close to the installed object on the right side.

In Ref No. G8 of FIG. 9, the controller 250 ascertains the position of the vanishing point (VP) at which the left line(left_line) and the right line(right_line) of the installed object are extended and met. The vanishing point (VP) corresponds to the center of two installed objects. Accordingly, the controller 250 compares the vanishing point (VP), the center of the cart (Cart_CP), and a central point of a hallway between the installed objects (Hallway_CP). As a result of comparison, the controller 250 may confirm the central point of a hallway (Hallway_CP) is placed disproportionately toward the left side with respect to the cart, and may confirm the cart moves near the right side.

Additionally, when determining that the cart 100 is required to move near the installed object because the cart 100 is close to the installed object (W2) on the right side, the controller 250 generates a moving route such that the cart 100 is disposed close to the installed object (W2) on the right side, and allows the cart 100 to move close to the installed object (W2) on the right side.

FIG. 10 shows lines of installed objects sensed by obstacle sensors of the cart 100 when the cart 100 is disposed close to an installed object (W1) on the left side between the installed objects (W1, and W2) on both sides (G9).

The controller 250 disposes the cart 100 in parallel with the installed objects using a rate or a difference in degrees (θ_{L}, and θ_{R}) to which the two lines are tilted. Additionally, the controller 250 may confirm which of the two installed objects (W1, and W2) is closer to the cart using a vanishing point of the two lines.

In Ref No. G10, the controller 250 ascertains the position of the vanishing point (VP) at which the left line(left_line) and the right line(right line) of the installed object are extended and met. The vanishing point (VP) corresponds to the center of two installed objects. Accordingly, the controller 250 compares the vanishing point (VP), the center of the cart (Cart_CP), and a central point of a hallway between the installed objects (Hallway_CP). As a result of comparison, the controller 250 may confirm the central point of a hallway (Hallway_CP) is placed disproportionately toward the right side with respect to the cart, and may confirm the cart moves near the left side.

Additionally, when determining that the cart 100 is required to move near the installed object because the cart 100 is close to the installed object (W1) on the left side, the controller 250 generates a moving route such that the cart 100 is disposed close to the installed object (W1) on the left side, and allows the cart 100 to move close to the installed object (W1) on the left side.

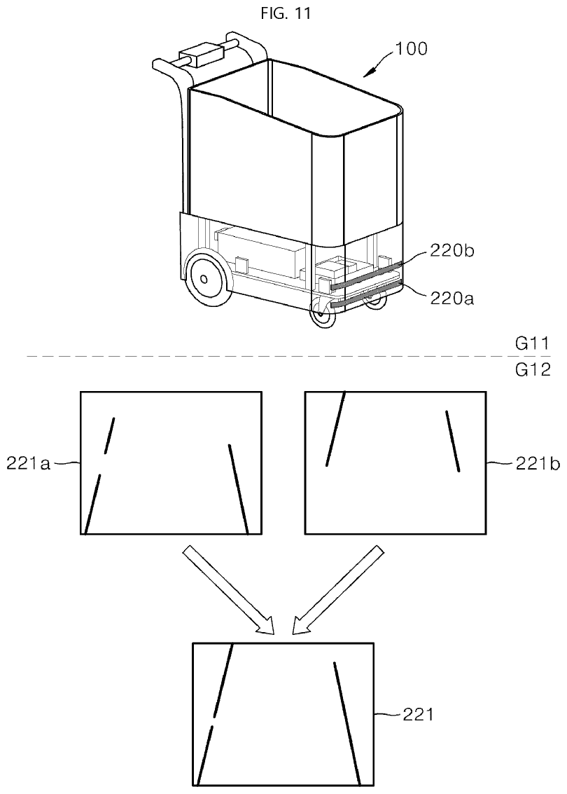

FIG. 11 shows results of detecting lines using sensors disposed at different heights according to an embodiment.

Ref No. G11 in FIG. 11 shows a configuration in which obstacle sensors 220a, 220b are disposed at two different heights in the cart 100. Due to different heights, an obstacle in a specific position may be sensed by any one of the two sensors. Accordingly, each of the obstacle sensors 220a, 220b may produce different results of sensing, as in G12.

The controller 250 detects and generates line segments of an installed object by reflecting values sensed by an obstacle sensor 220a at a lower end (first height), as in 221a. Additionally, the controller 250 generates line segments of an installed object by reflecting values sensed by an obstacle sensor 220b at an upper end (second height), as in 221b.

Additionally, the controller 250 combines the line segments detected and generated at two heights as in Ref No. 221. The controller 250 may collect values sensed at two different heights and may detect lines of installed objects. Further, the controller 250 allows the cart to move in parallel with the installed objects on the basis of the lines of the installed objects.

The controller 250 may generate line segments in response to obstacles sensed by obstacle sensors at different heights or various types of obstacle sensors at the same height. Additionally, the controller 250 generates a single line by extending or overlapping a plurality of line segments. The controller 250 allows the cart to turn left/turn right/move straight using an angle formed by the single line and a reference line (horizontal line).

According to embodiments of the present disclosure, the cart capable of autonomously moving/semi-autonomously moving may be driven efficiently even in narrow spaces. Additionally, the cart may move straight in parallel with installed objects without using various sensors in the absence of a map of an entire space such as a mart.

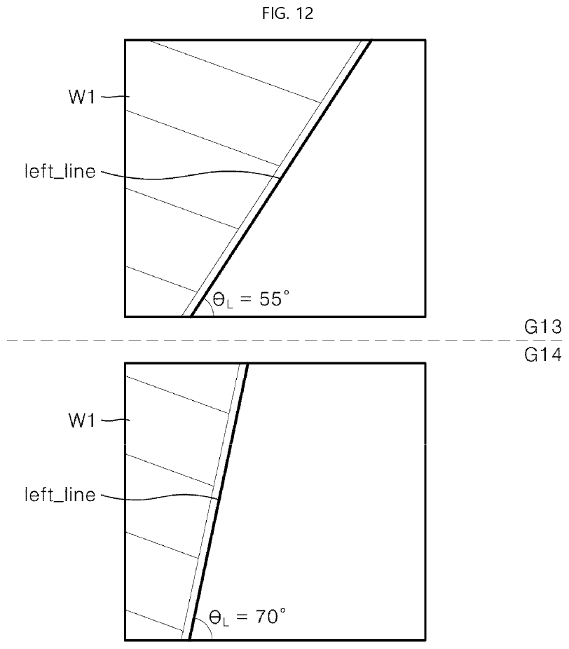

FIG. 12 shows a single installed object sensed according to an embodiment.

The obstacle sensor 220 senses an installed object (W1) on the left side as in G13 of FIG. 12. The controller 250 detects a line (left_line) corresponding to the installed object in G13. In this case, the controller 250 may calculate an angle between the line and a reference line. G13 shows the angle is 55 degrees.

The controller 250 determines the angle is not adequate for parallel movements of the cart. To satisfy conditions for parallel movements of the cart, a range of angles may vary depending on carts 100. As an example, the controller 250 may store a range of angles between the line and the reference line in the 70 to 90 degrees.

That is, when determining an angle between a line and a reference line is beyond a range of angles (e.g., 70 to 90 degrees) for parallel movements, the controller 250 generates a moving route such that the cart is disposed in parallel with installed objects. Additionally, the controller 250 may check an angle between a line corresponding to an installed object that is detected while the cart is moving, and a reference line, to re-generate a moving route such that the angle may be within the range of angles (e.g., 70 to 90 degrees) for parallel movements. The embodiment of FIG. 12 may also be applied to an installed object on the right side.

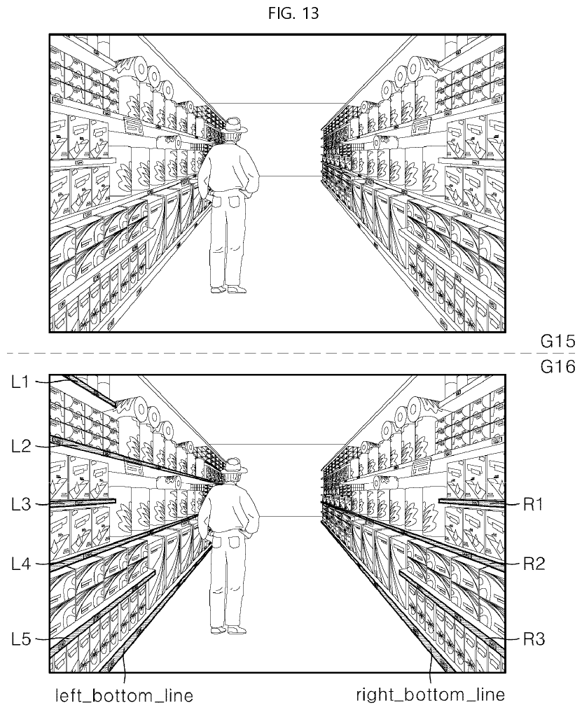

FIG. 13 shows lines that are detected when an obstacle sensor according to an embodiment is a camera sensor capturing images.

Ref No. G15 in FIG. 13 shows an image of a front side, captured by a camera sensor attached to the cart. The controller 250 detects oblique lines from the image of G15 in a direction in which the cart moves. G16 shows lines detected by the controller 250. The controller 250 selects two lowermost lines (left_bottom_line, and right_bottom_line) among the detected lines (L1, L2, L3, L4, L5, left_bottom_line, R1, R2, R3, and right_bottom_line), and controls parallel movements of the cart using the two selected lowermost lines.

In an image in which shelves and display stands are captured, the controller 250 detects a plurality of lines that are oblique lines in a direction in which the cart moves as in G16 of FIG. 13. In this case, the controller 250 selects lines closest to the ground among the plurality of lines. When selecting lines closest to the ground, i.e., a line detected at the lowermost position on the left side and a line detected at the lowermost position on the right side, the controller 250 may confirm installed objects and a direction of the cart accurately.

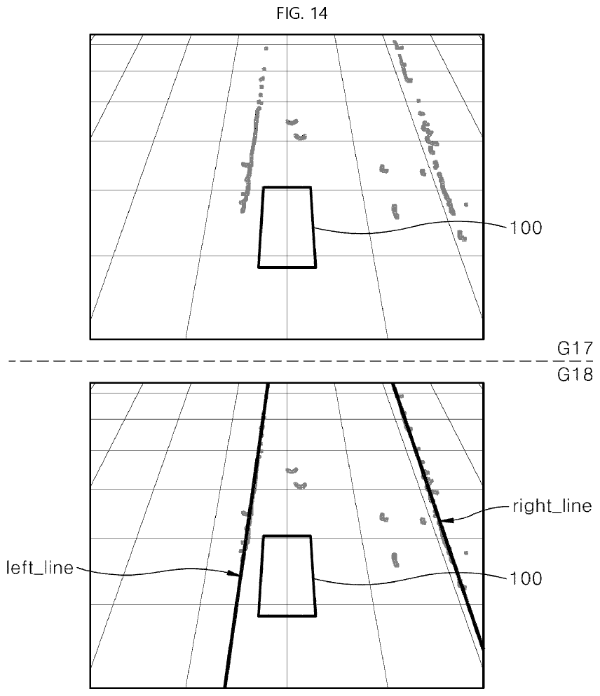

FIG. 14 shows lines that are detected when an obstacle sensor according to an embodiment is a LiDAR sensor. G17 shows results of sensing obstacles around the cart 100 by a LiDAR sensor through a two-dimensional plane. Tiny dots are disposed at each point. Each dot denotes a position in which an obstacle is sensed. The controller 250 detects and generates a left line(left_line) and a right line(right_line) by connecting the dots, as in G18.

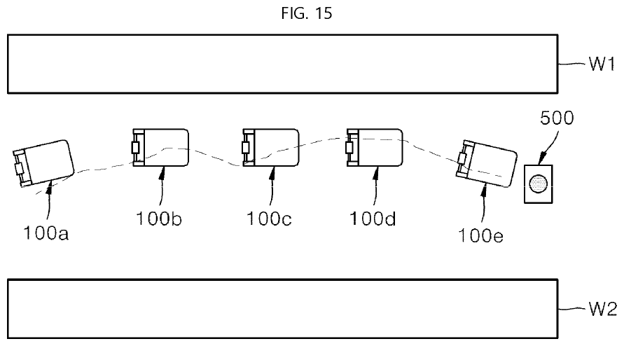

FIG. 15 shows a process in which a cart moves in parallel with lines of installed objects in a following mode according to an embodiment.

When the cart 100 is in a following mode, a trajectory of a user carrying the transmitter module 500 is indicated as a dotted line, and the cart 100 moves along the dotted line. The cart 100 is disposed between two installed objects (W1, and W2) that are disposed in parallel.

A positioning sensor 210 installed in the cart receives a signal from a transmitter module 500, and measures the position of the transmitter module 500. The controller 250 generates a moving route corresponding to position information of the transmitter module 500. Accordingly, the cart may move while following a user. Additionally, the controller 250 generates a moving route in parallel with installed objects while following a trajectory (dotted line) of the transmitter module 500. Thus, the controller 250 generates a moving route parallel to lines of the installed objects. As a result, the cart moves to positions such as 100a, 100b, 100c, 100d, and 100e.

The cart, as in FIG. 15, moves while being kept parallel to the installed objects in the following mode. Accordingly, a collision among a plurality of carts may be prevented in a space.

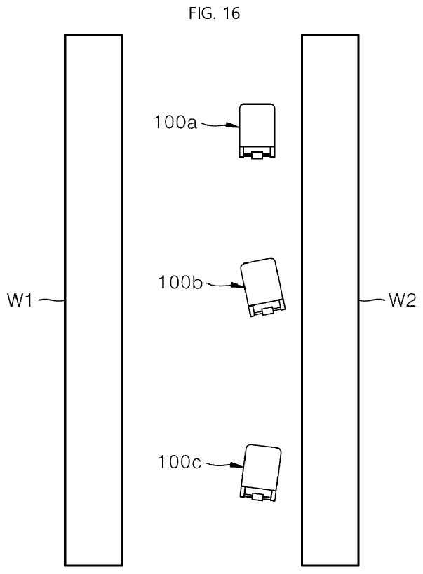

FIG. 16 shows a process in which a cart according to an embodiment moves in parallel with installed objects. FIG. 16 shows a process in which the controller 250 controls a speed at which the cart moves or a direction in which the cart moves, using magnitude of forces sensed by a force sensor 240 and lines of installed objects, such that the cart may be parallel to the lines of installed objects.

As illustrated in FIG. 16, the cart 100 moves between installed objects (W1, and W2). The direction and speed of the cart 100 are determined on the basis of control of the user, and the cart 100 moves in a power assist mode. In this process, if the user applies a different magnitude of forces to a left force sensor and a right force sensor by controlling a handle assembly of the cart 100, the cart may turn left and right, or may move straight. Table 1 shows each case (100a, 100b, and 100c) in relation to this.

When there is no installed object around the cart, a difference between a left force and a right force corresponds to an angle of the direction of the cart 100. For example, when a difference between a left force and a right force is −10 degrees, the cart 100 turns left by 10 degrees. When a difference between a left force and a right force is 20 degrees, the cart 100 turns right by 20 degrees.

The cart 100a in FIG. 16 is moving in parallel with an installed object. When a difference in forces sensed by left and right force sensors of the handle assembly is −10 degrees (control for moving the cart left), the controller 250 allows the cart 100a to move straight not to move left. On the contrary, when a difference in forces sensed by the left and right force sensors is +10 degrees (control for moving the cart right), the controller 250 allows the cart to move straight not to move right. When there is little difference in left and right forces, the controller 260 allows the cart 100a to move in parallel.

However, when a difference between left and right forces is greater than a certain magnitude (e.g., 20 degrees or more), the controller 250 moves the cart 100 left or right according to a user's intention. Even in this case, the controller 250 may adjust a direction such that an angle between the cart 100 and an installed object may be almost parallel.

For example, when there is no installed object around the cart in the case in which a difference (+ or −) in forces is 20 degrees, the controller 250 may allow the cart 100 to turn in a direction of 20 degrees to the right or the left. However, in the case of the cart 100a moving in parallel with an installed object, the controller 250 may allow the cart to turn in a direction of 15 degrees (less than 20 degrees) to the right or the left.

The cart 100b is moving away from (further to the left) an installed object. The case in which a difference in forces sensed by the left and right force sensors of the handle assembly is −10 degrees (control for moving the cart left) is described as follows.

The controller 250 moves the cart 100b in a direction of five degrees to the left while confirming that the cart 100b is moving away from an installed object (W2) such that the cart 100b may slightly move away from the installed object (W2). When a difference in forces sensed by the left and right force sensors is +10 degrees (control for moving the cart right), the controller 250 moves the cart 100b in a direction of 15 degrees to the right toward the installed object such that the cart 100b may be kept parallel to the installed object. When there is little difference between left and right forces, the controller 250 changes a direction such that the cart 100b may be parallel to the installed object (W2), or such that an angle between the cart 100b and the installed object (W2) may become small.

However, when a difference in forces is greater than a certain magnitude (e.g., 20 or more degrees), the controller 250 moves the cart 100 left or right according to a user's intention. Even in this case, the controller 250 may control a direction of the cart 100b such that an angle between the cart 100b and an installed object may be almost parallel, or such that the cart 100b may not turn in a direction of an angle greater than a straight angle.

For example, when there is no installed object around the cart in the case in which a difference in forces is 20 degrees, the controller 250 allows the cart 100 to turn in a direction of 20 degrees. However, in the case of the cart 100b moving away from an installed object, the controller 250 allows the cart 100b to turn in a direction of 15 degrees to the left and in a direction of 25 degrees to the right such that the cart 100b may be parallel to the installed object.

The cart 100c is moving close to an installed object. The case in which a difference in forces sensed by the left and right force sensors of the handle assembly is −10 degrees (control for moving the cart left) is described as follows.

The controller 250 moves the cart 100c in a direction of 15 degrees to the left toward an installed object (W2) while confirming that the cart 100c is moving close to the installed object (W2) (biased to the right) such that the cart 100c may be almost parallel to the installed object (W2). When a difference in forces sensed by the left and right force sensors is +10 degrees (control for moving the cart right), the controller 250 moves the cart 100c in a direction of five degrees to the right such that an angle between the cart 100c and the installed object may not be overly increased. When there is little difference between left and right forces, the controller 250 changes a direction such that the cart 100c may be parallel to the installed object (W2), or such that an angle between the cart 100c and the installed object (W2) may become small.

However, when a difference in forces is greater than a certain magnitude (e.g., 20 or more degrees), the controller 250 moves the cart 100 left or right according to a user's intention. Even in this case, the controller 250 may control the cart 100c such that an angle between the cart 100c and an installed object may be almost a straight angle, or such that the cart 100c may not turn in a direction of an angle greater than a straight angle.

For example, when there is no installed object around the cart in the case in which a difference in forces is 20 degrees, the controller 250 allows the cart 100 to turn in a direction of 20 degrees. However, in the case of the cart 100c moving close to an installed object, the controller 250 allows the cart 100c to turn in a direction of 25 degrees to the left and in a direction of 15 degrees to the right such that the cart 100c may be parallel to the installed object.

TABLE 1

| LEFT | PARALLEL TO | AWAY FROM | TOWARD |
|---|---|---|---|
| FORCE − | INSTALLED | INSTALLED | INSTALLED |
| RIGHT | OBJECT | OBJECT | OBJECT |
| FORCE | (100a) | (100b) | (100c) |
| −10 | STRAIGHT | −5 DEGREES | −15 DEGREES |
| | | TO THE LEFT | TO THE LEFT |
| +10 | STRAIGHT | −15 DEGREES | −5 DEGREES |
| | | TO THE RIGHT | TO THE RIGHT |
| −20 | −15 DEGREES | −15 DEGREES | −25 DEGREES |
| | TO THE LEFT | TO THE LEFT | TO THE LEFT |
| +20 | −15 DEGREES | −25 DEGREES | −15 DEGREES |
| | TO THE RIGHT | TO THE RIGHT | TO THE RIGHT |

Then when the user takes the user's hands off from the handle assembly, i.e., when the force sensor no longer senses forces, the controller 250 controls a direction in which the cart moves such that the cart may be parallel to lines of installed objects, as in FIG. 15. Additionally, the controller 250 reduces a speed at which the cart moves to stop the cart.

According to the embodiments of the present disclosure, the cart may detect lines of installed objects such as walls, display stands and the like, and may move in parallel with the installed objects, thereby enhancing efficiency of movements of the cart in a space.

According to the embodiments of the present disclosure, the cart may move in parallel to avoid a collision with a plurality of carts, thereby reducing the possibility that a cart autonomously or semi-autonomously moving collides with another cart.

According to the embodiments of the present disclosure, the cart may sense a parallel direction in a space, thereby controlling a direction in which the cart moves without an additional device.

When all elements of the embodiments of the invention are described to be combined into one element or to operate in combination, the invention is not limited to the embodiments and all the elements may be selectively combined to operate within the scope of the invention. All the elements may be embodied can be embodied as independent hardware pieces, respectively, or some or all of the elements may be selectively combined and may be embodied as a computer program including a program module that performs some or all functions combined into one or more hardware pieces. Codes or code segments of the computer program can be easily inferred by those skilled in the art. The computer program can be stored in a computer-readable recording medium and can be read and executed by a computer, whereby the embodiments of the invention can be realized. Examples of a storage medium having stored the computer program include storage mediums such as a magnetic recording medium, an optical recording medium, and a semiconductor recording medium. The computer program for realizing the embodiments of the invention includes a program module which is transmitted via an external device in real time.

While embodiments of the invention have been described above, various changes or modifications can be made thereon by those skilled in the art. Accordingly, it should be understood that such changes and modifications belong to the scope of the invention without departing from the scope of the invention.

1. A cart for moving in parallel with an installed object, comprising:
an obstacle sensor configured to sense an obstacle around the cart;
a controller configured to:
detect lines of installed objects around the cart, and
generate a moving route for the cart based on values sensed by the obstacle sensor; and
a driver configured to move the cart along the moving route.

2. The cart of claim 1, wherein the controller is further configured to:
detect a left line corresponding to a first installed object on a left side of the cart, and a right line corresponding to a second installed object on a right side of the cart,
calculate a first angle between the left line and a reference line,
calculate a second angle between the right line and the reference line, and
generate the moving route for moving the cart in parallel with the first installed object or the second installed object based on comparing the first angle with the second angle.

3. The cart of claim 2, wherein the controller is further configured to:
generate a vanishing point based on extending the left line and the right line, and
generate the moving route for moving the cart along a direction closer to one of the first or second installed objects based on comparing a position of the vanishing point with a center of the cart.

4. The cart of claim 2, wherein the controller is further configured to:
determine an angular velocity of a left wheel of the driver or an angular velocity of a right wheel of the driver based on a rate of change of the first angle or the second angle.

5. The cart of claim 1, wherein at least one of the lines includes a plurality of discontinuous line segments, and
wherein the controller is further configured to virtually extend portions of the plurality of discontinuous line segments to generate a single line.

6. The cart of claim 1, wherein the obstacle sensor includes a first obstacle sensor disposed at a first height and a second obstacle sensor disposed at a second height different from the first height, and
wherein the controller is further configured to:
detect a first line segment of an installed object using values sensed by the first obstacle sensor,
detect a second line segment of the installed object using values sensed by the second obstacle sensor, and
generate at least one of the lines by overlapping the first line segment and the second line segment.

7. The cart of claim 1, wherein the obstacle sensor is a LiDAR sensor or a distance sensor, and
wherein the controller is further configured to:
generate a line segment based on associating distance information of an obstacle at a first point with distance information on another obstacle at a second point, and
generate a single line using a plurality of adjacent line segments.

8. The cart of claim 1, wherein the obstacle sensor is a camera sensor, and
wherein the controller is further configured to:
detect an oblique line in a forward direction in an image captured by the camera sensor.

9. The cart of claim 1, further comprising:
a positioning sensor configured to receive a signal from a transmitter module and measure a position of the transmitter module,
wherein the controller is further configured to:
generate the moving route to be parallel to the lines of the installed objects based on position information of the transmitter module.

10. The cart of claim 1, further comprising:
a force sensor configured to sense a force applied to a handle assembly of the cart,
wherein the controller is further configured to:
control a speed of the cart or a direction of the cart based on a magnitude of the force sensed by the force sensor and the lines of the installed objects to orient the cart to be parallel to the lines of the installed objects.

11. The cart of claim 10, wherein the controller is further configured to:
when the force sensor does not sense any force applied to the handle assembly, control the direction or reduce the speed to orient the cart to be parallel to the lines of the installed objects.

12. The cart of claim 1, wherein the controller is further configured to:
detect a line corresponding to an installed object on a left side of the cart or on a right side of the cart,
generate the moving route based on calculating an angle between the line and a reference line for orientating the cart to be parallel with the installed object, and
update the moving route to maintain an angle between the line, detected while the cart is moving and the reference line to be in a range of 70 to 90 degrees.

13. A method of moving a cart in parallel with an installed object, the method comprising:
sensing, by an obstacle sensor of the cart, an obstacle around the cart;
detecting, by a controller of the cart, a left line corresponding to a first installed object on a left side of cart and a right line corresponding to a second installed object on a right side of the cart based on values sensed by the obstacle sensor;
calculating, by the controller, a first angle between the left line and a reference line;
calculating, by the controller, a second angle between the right line and the reference line; and
generating, by the controller, a moving route for moving the cart in parallel with the first installed object or the second installed object based on comparing the first angle with the second angle.

14. The method of claim 13, further comprising:
generating a vanishing point based on extending portions of the left line and the right line; and
generating the moving route by comparing a position of the vanishing point with a center of the cart to orient the cart to be closer to one of the first installed object or the second installed object.

15. The method of claim 13, further comprising:
determining an angular velocity of a left wheel of a driver configured to move the cart or an angular velocity of a right wheel of the driver based on a rate of change of the first angle or the second angle.

16. The method of claim 13, further comprising:
detecting, by the controller, a first line of the first or second installed object using values sensed by a first obstacle sensor included in the obstacle sensor, the first obstacle sensor being disposed at a first height;
detecting, by the controller, a second line of the first or second installed object using values sensed by a second obstacle sensor included in the obstacle sensor, the second obstacle sensor being disposed at a second height; and
generating, by the controller, the left line or the right line by overlapping the first line and the second line.

17. A method of moving a cart in parallel with an installed object, the method comprising:
sensing, by an obstacle sensor of the cart, an obstacle around the cart;
detecting, by a controller of the cart, a line corresponding to an installed object on a left side of the cart or a right side of the cart;
calculating, by the controller, an angle between the line and a reference line to generate a moving route for moving the cart in parallel with the installed object; and
updating, by the controller, the moving route to maintain an angle between the line, detected while the cart is moving and the reference line to be within a range of 70 to 90 degrees.

18. The method of claim 17, wherein the obstacle sensor includes a first obstacle sensor disposed at a first height and a second obstacle sensor disposed at a second height, and
wherein the method further comprises:
detecting, by the controller, a first line of the installed object based on values sensed by the first obstacle sensor;
detecting, by the controller, a second line of the installed object based on values sensed by the second obstacle sensor; and
generating, by the controller, the line by overlapping the first line and the second line.

19. The cart of claim 1, wherein the installed objects include at least one of a wall, a store isle, a product isle, a sign, or a fence.

20. The method of claim 13, further comprising:
generating a virtual line extension portion for a discontinuous line segment corresponding to the left line or the right line; and
updating the moving route for the cart based on the virtual extension portion.
